(19) United States
(12) Patent Application Publication
(10) Pub. No.: US 2024/0399997 A1
(43) Pub. Date: Dec. 5, 2024

(54) COUNTERACT ROTATION OF DRIVE WHEELS OF A VEHICLE BASED ON AN INDICATION OF UNAUTHORIZED USE

(71) Applicant: MICROCHIP TOUCH SOLUTIONS LIMITED, Wokingham (GB)

(72) Inventor: Ashfaq Alam Juna, Wokingham (GB)

(21) Appl. No.: 18/529,786

(22) Filed: Dec. 5, 2023

Related U.S. Application Data
(60) Provisional application No. 63/470,287, filed on Jun. 1, 2023.

(51) Int. Cl. B60R 25/09; B60R 25/32

(52) U.S. Cl. CPC B60R 25/09; B60R 25/32

(57) ABSTRACT

A method is provided that includes receiving an indication of unauthorized use of a vehicle that includes a motor to generate torques that are applied to one or more drive wheels to cause the one or more drive wheels to rotate and propel the vehicle. The method includes receiving a sensed input from the one or more sensors. The method includes, based on the indication of the unauthorized use of the vehicle, commanding the motor to generate a torque that is opposite the indicated rotational motion of the one or more drive wheels, with the generated torque applied to the one or more drive wheels to counteract the indicated rotational motion of the one or more drive wheels.

### CROSS-REFERENCE TO RELATED APPLICATION(S)

The present application claims priority to U.S. Provisional Patent Application No. 63/470,287, entitled: Operation of a Vehicle to Counteract Rotation of Drive Wheels During Unauthorized Use, filed on Jun. 1, 2023, the content of which is hereby incorporated by reference in its entirety.

### TECHNOLOGICAL FIELD

The present disclosure relates generally to vehicular engineering and, in particular, to counteracting rotation of drive wheels of a vehicle based on an indication of unauthorized use.

### BACKGROUND

Small motor vehicles such as electric bicycles (e-bicycle) and motorized scooters (e-scooters) have gained popularity in recent years due to their convenience and eco-friendly nature. They are compact, lightweight, and offer a practical mode of transportation for short distances within cities. However, their small size and portability make them susceptible to theft.

E-bikes and e-scooters are attractive targets for thieves for several reasons. Firstly, their compact design allows thieves to easily lift or carry them away without much effort. They are also relatively easy to disassemble, making it possible for thieves to quickly remove valuable components and sell them separately. Additionally, the increasing popularity of these vehicles has made them more desirable and valuable, increasing their appeal to thieves.

It would therefore be desirable to have a system and method that takes into account at least some of the issues discussed above, as well as other possible issues.

### BRIEF SUMMARY

Example implementations of the present disclosure are directed to vehicular engineering and, in particular, to counteracting rotation of drive wheels of a vehicle based on an indication of unauthorized use, such as by a thief who has stolen the vehicle. The present disclosure includes, without limitation, the following example implementations.

Some example implementations provide a vehicle comprising: a motor to generate torques that are applied to one or more drive wheels to cause the one or more drive wheels to rotate and propel the vehicle; one or more sensors to provide a sensed input that indicates rotational motion of the one or more drive wheels; and processing circuitry to at least: receive an indication of unauthorized use of the vehicle; receive the sensed input from the one or more sensors; and based on the indication of the unauthorized use of the vehicle, command the motor to generate a torque that is opposite the indicated rotational motion of the one or more drive wheels, the generated torque applied to the one or more drive wheels to counteract the indicated rotational motion of the one or more drive wheels.

Some example implementations provide an apparatus comprising: a memory to store computer-readable program code; and processing circuitry to access the memory, and execute the computer-readable program code to cause the apparatus to at least: receive an indication of unauthorized use of a vehicle that includes a motor to generate torques that are applied to one or more drive wheels to cause the one or more drive wheels to rotate and propel the vehicle; receive a sensed input from one or more sensors that indicates rotational motion of the one or more drive wheels; and based on the indication of the unauthorized use of the vehicle, command the motor to generate a torque that is opposite the indicated rotational motion of the one or more drive wheels, the generated torque applied to the one or more drive wheels to counteract the indicated rotational motion of the one or more drive wheels.

Some example implementations provide a method comprising: receiving an indication of unauthorized use of a vehicle that includes a motor to generate torques that are applied to one or more drive wheels to cause the one or more drive wheels to rotate and propel the vehicle; receiving a sensed input from one or more sensors that indicates rotational motion of the one or more drive wheels; and based on the indication of the unauthorized use of the vehicle, commanding the motor to generate a torque that is opposite the indicated rotational motion of the one or more drive wheels, the generated torque applied to the one or more drive wheels to counteract the indicated rotational motion of the one or more drive wheels.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a vehicle according to some example implementations of the present disclosure;

FIG. 2 illustrates a vehicle that may correspond to the vehicle of FIG. 1, in which a motor of the vehicle of FIG. 1 is a brushless direct current (BLDC) motor, according to some example implementations;

FIG. 3 illustrates an apparatus according to some example implementations;

FIG. 4 is a block diagram of various components of an e-scooter, according to some example implementations;

FIGS. 5A, 5B and 5C are flowcharts illustrating various steps in a method according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be approximate to account for acceptable variations that may occur, such as those due to engineering tolerances or the like.

As used herein, unless specified otherwise or clear from context, the “or” of a set of operands is the “inclusive or” and thereby true if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate to counteracting rotation of drive wheels of a vehicle based on an indication of unauthorized use. As used herein, a vehicle is a machine designed as an instrument of conveyance, such as by ground. Some example implementations are particularly applicable to wheeled vehicles that move over land by wheels. These vehicles include motor vehicles that include one or more motors to provide vehicle propulsion. Examples of suitable motor vehicles include cars, trucks, buses, motorcycles, electric bicycles (e-bicycle), scooters, motorized scooters (e-scooters), golf carts, and motorized wheelchairs. Other examples of suitable motor vehicles include electric trolley carts, electric lawnmowers and electric vacuum cleaners.

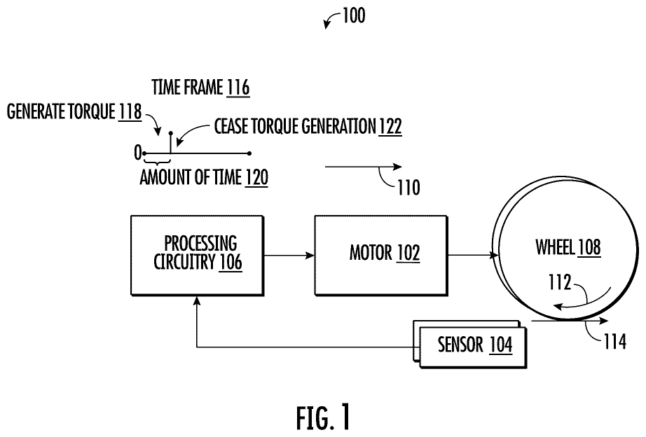

FIG. 1 illustrates a vehicle 100 according to some example implementations of the present disclosure. As shown, the vehicle includes a motor 102, one or more sensors 104, processing circuitry 106 one or more drive wheels 108. The processing circuitry 106 may include a general or specific-purpose processor, microprocessor, controller, or microcontroller, without limitation.

According to example implementations of the present disclosure, the motor 102 generates torques that are applied to the one or more drive wheels 108 to cause the one or more drive wheels to rotate and propel the vehicle, and the one or more sensors 104 provide a sensed input to processing circuitry 106, which sensed input indicates rotational motion of the one or more drive wheels 108. The processing circuitry 106 receives an indication of unauthorized use of the vehicle. Based on the indication of unauthorized use of the vehicle, and the sensed input that indicates rotational motion of the one or more drive wheels 108, the processing circuitry 106 commands the motor 102 to generate a torque that is opposite the indicated rotational motion of the one or more drive wheels 108. In one example, the sensed input from processing circuitry is provided to processing circuitry 106 based on an indication of unauthorized use of the vehicle. In one example, the sensed input from processing circuitry is provided to processing circuitry 106 irrespective of an indication of unauthorized use of the vehicle.

The torque generated by the motor 102 is applied to the one or more drive wheels 108 to counteract the indicated rotational motion of the one or more drive wheels. In some examples, the indicated rotational motion of the one or more drive wheels 108 is caused by an external force 110 that is applied to the vehicle 100 and thereby to the one or more drive wheels 108. In some of these examples, the generated torque is applied to the one or more drive wheels 108 by the motor 102 to counteract the external force 110.

In some examples, the processing circuitry 106 determines a direction of rotation 112 of the one or more drive wheels 108 from the sensed input, and the torque is generated by the motor 102 based on the determined direction of rotation. In some examples, the processing circuitry 106 may determine a rotational speed of the one or more drive wheels 108 from the sensed input that indicates rotational motion of the one or more drive wheels 108. The processing circuitry 106 may determine a magnitude of force 114 based on the determined rotational speed, and command the motor 102 to generate the torque that is opposite the indicated rotational motion of the one or more drive wheels having an equal magnitude of force.

In some examples, the processing circuitry 106 is to wait an amount of time after the sensed input that indicates rotational motion of the one or more drive wheels 108 is received, before the motor 102 is commanded to generate the torque. This amount of time may be selected in any of a number of different manners, but in some examples, the processing circuitry 106 randomly (true random or pseudorandom) selects the amount of time from within a defined time frame 116 (e.g., 0.5 to 5 seconds).

As shown on the defined time frame 116, in some examples, the processing circuitry 106 may command the motor 102 to generate the torque 118 for an amount of time 120, with the motor 102 ceasing generation 122 of the torque after the amount of time 120. Similar to the amount of time the processing circuitry 106 waits to command the motor 102, the amount of time for which the motor 102 is commanded to generate the torque may be selected in any of a number of different manners, such as randomly (true random or pseudorandom) from within a defined time frame. In some further examples, then, the processing circuitry 106 may receive the sensed input again after the amount of time, with the sensed input indicating the rotational motion of the one or more drive wheels 108 a second time. The processing circuitry 106 may then command the motor 102 to again generate the torque to counteract the indicated rotational motion.

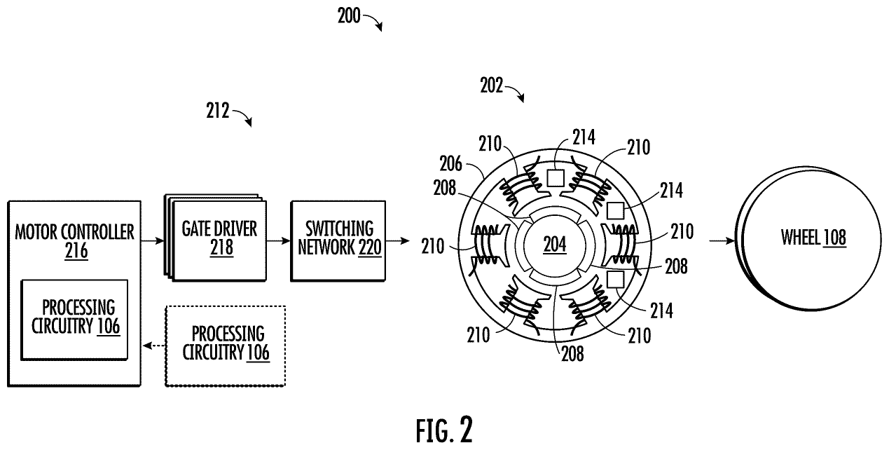

FIG. 2 illustrates a vehicle 200 that may correspond to the vehicle 100, in which the motor 102 is a brushless direct current (BLDC) motor 202, according to some example implementations. As shown, the BLDC motor 202 includes a rotor 204 that rotates within a stator 206. The rotor 204 includes rotor magnets 208, and the stator includes stator windings 210 through which current flow is switched to generate a rotating magnetic field to cause the rotor 204 to rotate. The vehicle also includes a BLDC motor driver 212 to drive the BLDC motor 202.

In some examples, the BLDC motor driver 212 includes one or more position sensors 214 to measure a position of the rotor 204. The one or more sensors 104 that provide the sensed input to the processing circuitry 106 may include the one or more position sensors 214, and the sensed input may include the position of the rotor 204, and a change in the position of the rotor 204 that indicates the rotational motion of the one or more drive wheels 108. The BLDC motor driver 212 may also include a motor controller 216 to control electrical commutation of the BLDC motor 202 based on the sensed input from the one or more position sensors 214. In particular, the motor controller 216 may control switching of the current flow through the stator windings 210, and thereby control the electrical commutation of the BLDC motor 202. In some examples, the BLDC motor driver 212 also includes one or more gate drivers 218 and a switching network 220 by which the current flow through the stator windings 210 is switched.

According to some example implementations, the motor controller 216 includes the processing circuitry 106 that receives the sensed input that indicates the rotational motion of the one or more drive wheels 108. The processing circuitry 106 of the motor controller 216 (based on the indication of the unauthorized use) commands the BLDC motor 202 (via the gate driver 218 and switching network 220) to generate a torque that is opposite the indicated rotational motion of the one or more drive wheels. In other examples, the processing circuitry 106 is separate from the motor controller 216; and in some of these examples, the processing circuitry 106 commands the BLDC motor 202 via the motor controller 216, gate driver 218 and switching network 220. In some of these examples, the sensed is provided to processing circuitry 106 based on an indication of unauthorized use of the vehicle. In some of these examples, the sensed is provided to processing circuitry 106 irrespective of an indication of unauthorized use of the vehicle.

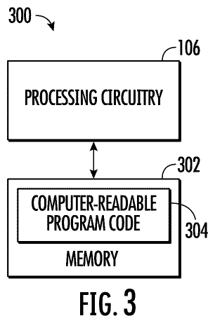

FIG. 3 illustrates an apparatus 300 including the processing circuitry 106, according to some example implementations of the present disclosure. As explained above, in some examples, the apparatus 300 may be implemented as the motor controller 216. In other examples, the apparatus 300 may be separate from the motor controller 216. In some of these other examples, the apparatus 300 may be implemented as a separate computer, such as a microcontroller. In this regard, the apparatus 300 may include memory 302 (also referred to as computer-readable storage medium) connected to the processing circuitry 106. The memory 302 may store computer-readable program code 304. The processing circuitry 106 may access the memory 302, and execute the computer-readable program code 304 to cause the apparatus 300 to perform operations described above with respect to the processing circuitry 106.

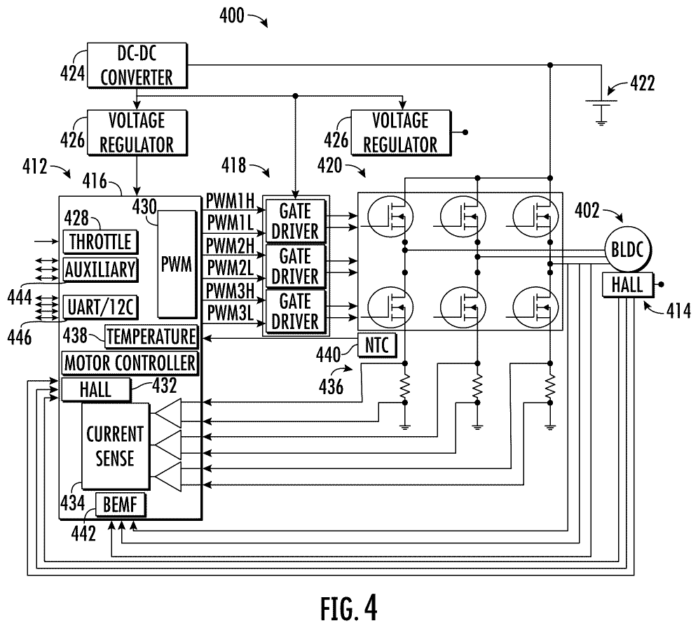

To further illustrate example implementations of the present disclosure, FIG. 4 is a block diagram of various components of an e-scooter 400, according to some example implementations. As shown, the e-scooter 400 may include a BLDC motor 402 and a BLDC motor driver 412 that may correspond to the BLDC motor 202 and BLDC motor driver 212 of FIG. 2. Similarly, the e-scooter 400 may include one or more Hall sensors 414, a motor controller 416 (that may include processing circuitry 106), one or more gate drivers 418, and a switching network 420, which may correspond to respective ones of the one or more position sensors 214, motor controller 216, one or more gate drivers 218, and switching network 220, respectively.

As also shown, the e-scooter 400 includes a power source 422, such as one or more batteries, a DC-DC converter 424 to step up or step down voltage from the power source 422 from one level to another, and one or more voltage regulators 426 to produce or maintain a steady and stable output voltage at one or more levels for various components of the e-scooter 400.

The motor controller 416 may include a number of functional components to control operation of the BLDC motor 402. The motor controller 416 may include a throttle block 428 to interface with a throttle mechanism of the e-scooter 400, and receive a rider's input, which the motor controller 416 may translate to appropriate control signals for the BLDC motor 402. In this regard, the motor controller 416 may include a pulse width modulation (PWM) block 430 to control the speed of the BLDC motor 402 by regulating a duty cycle of electrical pulses sent to the motor via the one or more gate drivers 418 and switching network 420.

The motor controller 416 may include a Hall block 432 to detect the position and speed of the rotor of the BLDC motor 402 responsive to input from the one or more Hall sensors 414, which may be used for sensor-based commutation of the BLDC motor 402. The motor controller 416 may include a current sense block 434 that (with current-sense resistors 436) measures current through the windings of the BLDC motor 402, which the motor controller 416 may use for various purposes such as current limiting, torque control, overcurrent protection, without limitation. The motor controller 416 may also include a temperature block 438 that (responsive to input from a negative temperature coefficient (NTC) thermistor 440 or other one or more temperature sensors) monitors the temperature of various components of the e-scooter 400, which the motor controller 416 may use to prevent overheating. A back electromotive force (BEMF) block 442 may detect voltage generated by the BLDC motor 402, which may be used to determine the position of the rotor.

As also shown, the motor controller 416 may include an auxiliary block 444 to serve various secondary functions, such as controlling lights, indicators, or other accessories of the e-scooter 400. The motor controller 416 may also include a universal asynchronous receiver-transmitter (UART)/inter-integrated circuit (I2C) interface 446 used by the motor controller 416 to exchange data with other components, such as a display, battery management system or external controller. Through the UART/I2C interface 446, the motor controller 416 may communicate with a user interface and/or a main controller of the e-scooter 400, and receive an indication of unauthorized use of the e-scooter 400.

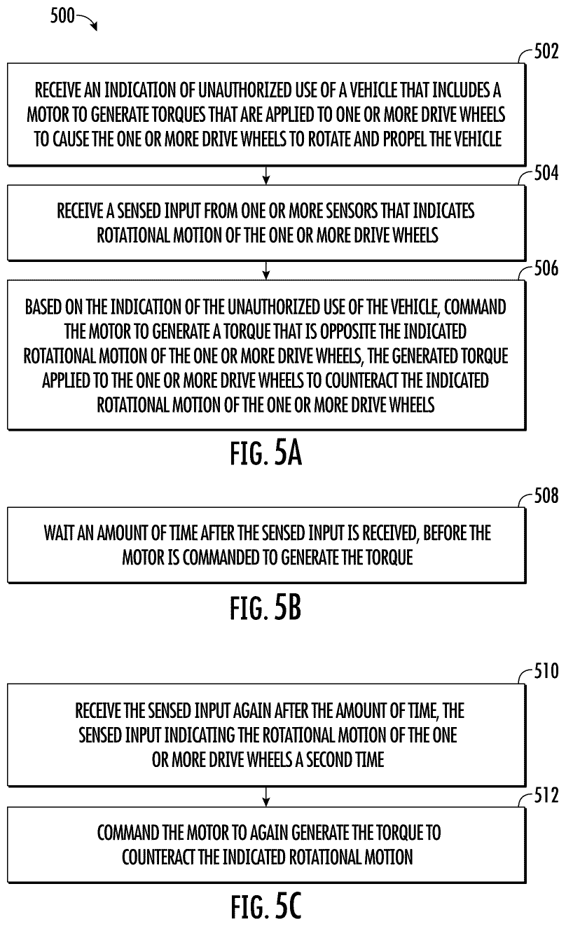

FIGS. 5A-5C are flowcharts illustrating various steps in a method 500 according to some example implementations. The method includes receiving an indication of unauthorized use of a vehicle that includes a motor to generate torques that are applied to one or more drive wheels to cause the one or more drive wheels to rotate and propel the vehicle, as shown at block 502 of FIG. 5A. Examples of such an indication of unauthorized use may include an alarm system signal or a signal from a remote monitoring station, without limitation. The method includes receiving a sensed input from one or more sensors that indicates rotational motion of the one or more drive wheels, as shown at block 504. The method includes, based on the indication of the unauthorized use of the vehicle, commanding the motor to generate a torque that is opposite the indicated rotational motion of the one or more drive wheels, the generated torque applied to the one or more drive wheels to counteract the indicated rotational motion of the one or more drive wheels, as shown at block 506.

In some examples, the indicated rotational motion of the one or more drive wheels is caused by an external force that is applied to the vehicle and thereby the one or more drive wheels. In some of these examples, the generated torque is applied to the one or more drive wheels to counteract the external force.

In some examples, the method 500 includes determining a direction of rotation of the one or more drive wheels from the sensed input, and the torque is generated in block 506 is based on the determined direction of rotation.

In some examples, the method 500 includes determining a rotational speed of the one or more drive wheels from the sensed input, and determining a magnitude of force based on the determined rotational speed. In some of these examples, the motor is commanded at block 506 to generate the torque that is opposite the indicated rotational motion of the one or more drive wheels having the determined magnitude of force.

In some examples, the method 500 includes waiting an amount of time after the sensed input is received, before the motor is commanded to generate the torque, as shown at block 508. In some further examples, the method includes randomly selecting the amount of time from within a defined time frame.

In some examples, the motor is commanded at block 506 to generate the torque for an amount of time, and the motor ceases generation of the torque after the amount of time. In some further examples, the method includes randomly selecting the amount of time from within a defined time frame.

In some examples, the method 500 includes receiving the sensed input again after the amount of time, the sensed input indicating the rotational motion of the one or more drive wheels a second time, as shown at block 510 of FIG. 5C. The method then also includes commanding the motor to again generate the torque to counteract the indicated rotational motion, as shown at block 512.

As explained above and reiterated below, the present disclosure includes, without limitation, the following example implementations.

Clause 1. A vehicle comprising: a motor to generate torques that are applied to one or more drive wheels to cause the one or more drive wheels to rotate and propel the vehicle; one or more sensors to provide a sensed input that indicates rotational motion of the one or more drive wheels; and processing circuitry to at least: receive an indication of unauthorized use of the vehicle; receive the sensed input from the one or more sensors; and based on the indication of the unauthorized use of the vehicle, command the motor to generate a torque that is opposite the indicated rotational motion of the one or more drive wheels, the generated torque applied to the one or more drive wheels to counteract the indicated rotational motion of the one or more drive wheels.

Clause 2. The vehicle of clause 1, wherein the indicated rotational motion of the one or more drive wheels is caused by an external force that is applied to the vehicle and thereby the one or more drive wheels, and the generated torque is applied to the one or more drive wheels to counteract the external force.

Clause 3. The vehicle of clause 1 or clause 2, wherein the processing circuitry is to determine a direction of rotation of the one or more drive wheels from the sensed input, and the torque is generated based on the determined direction of rotation.

Clause 4. The vehicle of any of clauses 1 to 3, wherein the processing circuitry is to determine a rotational speed of the one or more drive wheels from the sensed input, and wherein the processing circuitry is to determine a magnitude of force based on the determined rotational speed, and command the motor to generate the torque that is opposite the indicated rotational motion of the one or more drive wheels having the determined magnitude of force.

Clause 5. The vehicle of any of clauses 1 to 4, wherein the processing circuitry is to wait an amount of time after the sensed input is received, before the motor is commanded to generate the torque.

Clause 6. The vehicle of clause 5, wherein the processing circuitry is to randomly select the amount of time from within a defined time frame.

Clause 7. The vehicle of any of clauses 1 to 6, wherein the processing circuitry is to command the motor to generate the torque for an amount of time, and the motor is to cease generation of the torque after the amount of time.

Clause 8. The vehicle of clause 7, wherein the processing circuitry is to randomly select the amount of time from within a defined time frame.

Clause 9. The vehicle of clause 7 or clause 8, wherein the processing circuitry is to: receive the sensed input again after the amount of time, the sensed input indicating the rotational motion of the one or more drive wheels a second time; and command the motor to again generate the torque to counteract the indicated rotational motion.

Clause 10. The vehicle of any of clauses 1 to 9, wherein the motor is a brushless direct current (BLDC) motor, and the vehicle comprises a BLDC motor driver to drive the BLDC motor.

Clause 11. The vehicle of clause 10, wherein the BLDC motor includes a

rotor, and the one or more sensors include one or more position sensors to measure a position of the rotor, wherein the BLDC motor driver includes the one or more position sensors, the sensed input includes the position of the rotor, and a change in the position of the rotor that indicates the rotational motion of the one or more drive wheels.

Clause 12. The vehicle of clause 11, wherein the BLDC motor driver includes

a motor controller to control electrical commutation of the BLDC motor based on the sensed input from the one or more position sensors.

Clause 13. The vehicle of clause 12, wherein the rotor of the BLDC motor rotates within a stator, the rotor includes rotor magnets, and the stator includes stator windings through which current flow is switched to generate a rotating magnetic field to cause the rotor to rotate, and wherein the motor controller is to control switching of the current flow through the stator windings, and thereby control the electrical commutation of the BLDC motor.

Clause 14. The vehicle of clause 13, wherein the BLDC motor driver includes one or more gate drivers and a switching network by which the current flow through the stator windings is switched.

Clause 15. The vehicle of any of clauses 12 to 14, wherein the motor controller includes the processing circuitry.

Clause 16. The vehicle of any of clauses 12 to 15, wherein the processing circuitry is separate from the motor controller, and the processing circuitry is to command the motor via the motor controller.

Clause 17. An apparatus comprising: a memory to store computer-readable program code; and processing circuitry to access the memory, and execute the computer-readable program code to cause the apparatus to at least: receive an indication of unauthorized use of a vehicle that includes a motor to generate torques that are applied to one or more drive wheels to cause the one or more drive wheels to rotate and propel the vehicle; and based on the indication of the unauthorized use, receive a sensed input from one or more sensors that indicates rotational motion of the one or more drive wheels; and command the motor to generate a torque that is opposite the indicated rotational motion of the one or more drive wheels, the generated torque applied to the one or more drive wheels to counteract the indicated rotational motion of the one or more drive wheels.

Clause 18. The apparatus of clause 17, wherein the indicated rotational motion of the one or more drive wheels is caused by an external force that is applied to the vehicle and thereby the one or more drive wheels, and the generated torque is applied to the one or more drive wheels to counteract the external force.

Clause 19. The apparatus of clause 17 or clause 18, wherein the processing circuitry to execute the computer-readable program code to cause the apparatus to determine a direction of rotation of the one or more drive wheels from the sensed input, and the torque is generated based on the determined direction of rotation.

Clause 20. The apparatus of any of clauses 17 to 19, wherein the processing circuitry to execute the computer-readable program code to cause the apparatus to at least: determine a rotational speed of the one or more drive wheels from the sensed input; and determining a magnitude of force based on the determined rotational speed, and wherein the motor is commanded to generate the torque that is opposite the indicated rotational motion of the one or more drive wheels having the determined magnitude of force.

Clause 21. The apparatus of any of clauses 17 to 20, wherein the processing circuitry to execute the computer-readable program code to cause the apparatus to wait an amount of time after the sensed input is received, before the motor is commanded to generate the torque.

Clause 22. The apparatus of clause 21, wherein the processing circuitry to execute the computer-readable program code to cause the apparatus to randomly select the amount of time from within a defined time frame.

Clause 23. The apparatus of any of clauses 17 to 22, wherein the motor is commanded to generate the torque for an amount of time, and the motor ceases generation of the torque after the amount of time.

Clause 24. The apparatus of clause 23, wherein the processing circuitry to execute the computer-readable program code to cause the apparatus to randomly select the amount of time from within a defined time frame.

Clause 25. The apparatus of clause 23 or clause 24, wherein the processing circuitry to execute the computer-readable program code to cause the apparatus to at least: receive the sensed input again after the amount of time, the sensed input indicating the rotational motion of the one or more drive wheels a second time; and command the motor to again generate the torque to counteract the indicated rotational motion.

Clause 26. A method comprising: receiving an indication of unauthorized use of a vehicle that includes a motor to generate torques that are applied to one or more drive wheels to cause the one or more drive wheels to rotate and propel the vehicle; and based on the indication of the unauthorized use, receiving a sensed input from one or more sensors that indicates rotational motion of the one or more drive wheels; and commanding the motor to generate a torque that is opposite the indicated rotational motion of the one or more drive wheels, the generated torque applied to the one or more drive wheels to counteract the indicated rotational motion of the one or more drive wheels.

Clause 27. The method of clause 26, wherein the indicated rotational motion of the one or more drive wheels is caused by an external force that is applied to the vehicle and thereby the one or more drive wheels, and the generated torque is applied to the one or more drive wheels to counteract the external force.

Clause 28. The method of clause 26 or clause 27, wherein the method comprises determining a direction of rotation of the one or more drive wheels from the sensed input, and the torque is generated based on the determined direction of rotation.

Clause 29. The method of any of clauses 26 to 28, wherein the method comprises: determining a rotational speed of the one or more drive wheels from the sensed input; and determining a magnitude of force based on the determined rotational speed, and wherein the motor is commanded to generate the torque that is opposite the indicated rotational motion of the one or more drive wheels having the determined magnitude of force.

Clause 30. The method of any of clauses 26 to 29, wherein the method comprises waiting an amount of time after the sensed input is received, before the motor is commanded to generate the torque.

Clause 31. The method of clause 30, wherein the method comprises randomly selecting the amount of time from within a defined time frame.

Clause 32. The method of any of clauses 26 to 31, wherein the motor is commanded to generate the torque for an amount of time, and the motor ceases generation of the torque after the amount of time.

Clause 33. The method of clause 32, wherein the method comprises randomly selecting the amount of time from within a defined time frame.

Clause 34. The method of clause 32 or clause 33, wherein the method comprises: receiving the sensed input again after the amount of time, the sensed input indicating the rotational motion of the one or more drive wheels a second time; and commanding the motor to again generate the torque to counteract the indicated rotational motion.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A vehicle comprising:
a motor to generate torques that are applied to one or more drive wheels to cause the one or more drive wheels to rotate and propel the vehicle;
one or more sensors to provide a sensed input that indicates rotational motion of the one or more drive wheels; and
processing circuitry to at least:
receive an indication of unauthorized use of the vehicle;
receive the sensed input from the one or more sensors; and
based on the indication of unauthorized use of the vehicle, command the motor to generate a torque that is opposite the indicated rotational motion of the one or more drive wheels, the generated torque applied to the one or more drive wheels to counteract the indicated rotational motion of the one or more drive wheels.

2. The vehicle of claim 1, wherein the indicated rotational motion of the one or more drive wheels is caused by an external force that is applied to the vehicle and thereby the one or more drive wheels, and the generated torque is applied to the one or more drive wheels to counteract the external force.

3. The vehicle of claim 1, wherein the processing circuitry is to determine a direction of rotation of the one or more drive wheels from the sensed input, and the torque is generated based on the determined direction of rotation.

4. The vehicle of claim 1, wherein the processing circuitry is to determine a rotational speed of the one or more drive wheels from the sensed input, and wherein the processing circuitry is to determine a magnitude of force based on the determined rotational speed, and command the motor to generate the torque that is opposite the indicated rotational motion of the one or more drive wheels having the determined magnitude of force.

5. The vehicle of claim 1, wherein the processing circuitry is to wait an amount of time after the sensed input is received, before the motor is commanded to generate the torque.

6. The vehicle of claim 5, wherein the processing circuitry is to randomly select the amount of time from within a defined time frame.

7. The vehicle of claim 1, wherein the processing circuitry is to command the motor to generate the torque for an amount of time, and the motor is to cease generation of the torque after the amount of time.

8. An apparatus comprising:
a memory to store computer-readable program code; and
processing circuitry to access the memory, and execute the computer-readable program code to cause the apparatus to at least:
receive an indication of unauthorized use of a vehicle that includes a motor to generate torques that are applied to one or more drive wheels to cause the one or more drive wheels to rotate and propel the vehicle;
receive a sensed input from one or more sensors that indicates rotational motion of the one or more drive wheels; and,
based on the indication of the unauthorized use of the vehicle, command the motor to generate a torque that is opposite the indicated rotational motion of the one or more drive wheels, the generated torque applied to the one or more drive wheels to counteract the indicated rotational motion of the one or more drive wheels.

9. The apparatus of claim 8, wherein the indicated rotational motion of the one or more drive wheels is caused by an external force that is applied to the vehicle and thereby the one or more drive wheels, and the generated torque is applied to the one or more drive wheels to counteract the external force.

10. The apparatus of claim 8, wherein the processing circuitry to execute the computer-readable program code to cause the apparatus to determine a direction of rotation of the one or more drive wheels from the sensed input, and the torque is generated based on the determined direction of rotation.

11. The apparatus of claim 8, wherein the processing circuitry to execute the computer-readable program code to cause the apparatus to at least:
determine a rotational speed of the one or more drive wheels from the sensed input; and
determine a magnitude of force based on the determined rotational speed, and
wherein the motor is commanded to generate the torque that is opposite the indicated rotational motion of the one or more drive wheels having the determined magnitude of force.

12. The apparatus of claim 8, wherein the processing circuitry to execute the computer-readable program code to cause the apparatus to wait an amount of time after the sensed input is received, before the motor is commanded to generate the torque.

13. The apparatus of claim 12, wherein the processing circuitry to execute the computer-readable program code to cause the apparatus to randomly select the amount of time from within a defined time frame.

14. The apparatus of claim 8, wherein the motor is commanded to generate the torque for an amount of time, and the motor ceases generation of the torque after the amount of time.

15. A method comprising:
receiving an indication of unauthorized use of a vehicle that includes a motor to generate torques that are applied to one or more drive wheels to cause the one or more drive wheels to rotate and propel the vehicle;
receiving a sensed input from one or more sensors that indicates rotational motion of the one or more drive wheels; and
based on the indication of the unauthorized use of the vehicle, commanding the motor to generate a torque that is opposite the indicated rotational motion of the one or more drive wheels, the generated torque applied to the one or more drive wheels to counteract the indicated rotational motion of the one or more drive wheels.

16. The method of claim 15, wherein the indicated rotational motion of the one or more drive wheels is caused by an external force that is applied to the vehicle and thereby the one or more drive wheels, and the generated torque is applied to the one or more drive wheels to counteract the external force.

17. The method of claim 15, wherein the method comprises determining a direction of rotation of the one or more drive wheels from the sensed input, and the torque is generated based on the determined direction of rotation.

18. The method of claim 15, wherein the method comprises:
determining a rotational speed of the one or more drive wheels from the sensed input; and
determining a magnitude of force based on the determined rotational speed, and
wherein the motor is commanded to generate the torque that is opposite the indicated rotational motion of the one or more drive wheels having the determined magnitude of force.

19. The method of claim 15, wherein the method comprises waiting an amount of time after the sensed input is received, before the motor is commanded to generate the torque.

20. The method of claim 19, wherein the method comprises randomly selecting the amount of time from within a defined time frame.

21. The method of claim 15, wherein the motor is commanded to generate the torque for an amount of time. and the motor ceases generation of the torque after the amount of time.
